(19) United States
(12) Patent Application Publication
(10) Pub. No.: US 2010/0052874 A1
(43) Pub. Date: Mar. 4, 2010

(54) Open-loop monitoring system

(75) Inventors: Yi-Lin Tang, Tainan City (TW); Nan-Jan Huang, Tainan City (TW); Ruei-Cheng Liu, Tainan County (TW); Wang-Cheng Chen, Tainan City (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: HICO Technology Co., LTD., Tainan City (TW)

(21) Appl. No.: 12/583,798

(22) Filed: Aug. 25, 2009

(30) Foreign Application Priority Data
Sep. 1, 2008 (TW) 097133433
Sep. 26, 2008 (CN) 200820136976.1

(51) Int. Cl. G05B 11/01

(52) U.S. Cl. 340/310.11

(57) ABSTRACT

In an open-loop monitoring system, a host device is operable to output encoded signals at a coupling end to a single transmission line. Each of monitoring devices includes: a control unit identifying a monitoring signal from the encoded signals from the transmission line; and a detecting unit detecting, in response to the monitoring signal, whether each of electronic devices coupled thereto is activated or deactivated and transmitting a reply signal associated with states of the electronic devices to the transmission line based on a detection result made thereby. The host device receives the reply signal from each monitoring device through the transmission line and the coupling end to obtain state information associated with the electronic devices and determines whether the transmission line is cut off based on the reply signals from the monitoring devices.

### CROSS-REFERENCE TO RELATED APPLICATION

This application claims priority to Taiwanese Application No. 097133433, filed Sep. 1, 2008, the disclosure of which is incorporated herein by reference.

### BACKGROUND OF THE INVENTION

1. Field of the Invention

The invention relates to a monitoring system, more particularly to an open-loop monitoring system.

2. Description of the Related Art

Referring to FIG. 1, a conventional control system is shown to include a host device 11, and a plurality of control devices 13 coupled in series to the host device 11 through a single transmission line 12. The host device 11 is operable to generate encoded audio signals and encoded control signals, and outputs the encoded audio signals and the encoded control signals to the transmission line 12 through an output side 111 thereof. Each control device 13 has an input side 131 coupled to the transmission line 12, and includes: a signal current generating element 132 coupled across the input side 131 such that the encoded audio and control signals pass through the signal current generating element 132; a current inducting device 133 disposed adjacent to the signal current generating element 132 for generating induced signals when the encoded audio and control signals pass through the signal current generating element 132; and a control unit 134 coupled to the current inducting device 133, an electronic device 15, such as a lamp device, and a loudspeaker 14, receiving the induced signals from the current inducting device 133, identifying audio signals and a control signal from the induced signals received thereby, and outputting the audio signals and the control signal to the loudspeaker 14 and the electronic device 15, respectively, such that the audio signals are reproduced by the loudspeaker 14 and that the electronic device 15 is operated based on the control signal.

In such a configuration, distortion of the encoded signals can be minimized, thereby ensuring a stable signal transmission. However, when undesired operation of one electronic device 15 occurs, a user cannot determine whether said one electronic device 15 malfunctions or the transmission line 12 is cut off. As a result, after said one electronic device 15 is checked and determined to be normal, a long period of time is required to find an exact position where the transmission line 12 is cut off. Furthermore, each control device 13 is configured to only control operation of the single electronic device 15.

### SUMMARY OF THE INVENTION

Therefore, an object of the present invention is to provide an open-loop monitoring system that can overcome the aforesaid drawbacks of the prior art.

According to one aspect of the present invention, an open-loop monitoring system comprises:

a host device; and

a plurality of monitoring devices coupled to the host device through a single transmission line such that the host device, the monitoring devices and the transmission line constitute an open-loop structure.

The host device has a coupling end coupled to one end of the transmission line, and includes a signal generating unit coupled to the coupling end, operable to generate encoded signals and outputting the encoded signals through the coupling end to the transmission line.

Each of the monitoring devices includes
a control unit coupled to the transmission line for receiving the encoded signals therefrom, identifying a monitoring signal from the encoded signals received thereby, and outputting the monitoring signal, and
a detecting unit including
   a detector adapted to be coupled to a plurality of first electronic devices, coupled to the control unit for receiving the monitoring signal therefrom, detecting, in response to the monitoring signal received thereby, whether each of the first electronic devices is activated or deactivated, generating a detecting output associated with states of the first electronic devices based on a detection result made thereby, and
   a first modulator coupled to the detector and the transmission line, receiving the detecting output from the detector, modulating the detecting output received thereby so as to generate a reply signal that is in the form of carrier waves, and transmitting the reply signal to the coupling end of the host device through the transmission line.

The host device further includes a processing unit that includes
a demodulator coupled to the coupling end for receiving and demodulating the reply signal from each of the monitoring devices, and outputting the reply signal demodulated thereby, and
a processor coupled to the demodulator, receiving the reply signal from the demodulator and obtaining state information corresponding to the reply signal from each of the monitoring devices, the processor determining whether the transmission line is cut off based on the reply signals demodulated by the demodulator, and obtaining condition information indicating a section of the transmission line that is discontinuous by analyzing the reply signals when the transmission line is determined to be cut off.

According to another aspect of the present invention, an open-loop monitoring system comprises:

a host device; and

a plurality of monitoring devices coupled to the host device through a single transmission line such that the host device, the monitoring devices and the transmission line constitute an open-loop structure, each of the monitoring devices including
a detector adapted to be coupled to a plurality of electronic devices, detecting whether each of the electronic devices is activated or deactivated, generating a detecting output associated with states of the electronic devices based on a detection result made thereby, and
a modulator coupled to the detector and the transmission line, receiving the detecting output from the detector, modulating the detecting output received thereby so as to generate a reply signal that is in the form of carrier waves, and transmitting the reply signal to the transmission line.

The host device has a coupling end coupled to one end of the transmission line, and includes a processing unit that includes
a demodulator coupled to the coupling end for receiving and demodulating the reply signal from each of the monitoring devices, and outputting the reply signal demodulated thereby, and
a processor coupled to the demodulator, receiving the reply signal from the demodulator and obtaining state information corresponding to the reply signal from each of the monitoring devices, the processor determining whether the transmission line is cut off based on the reply signals demodulated by the demodulator, and obtaining condition information indicating a section of the transmission line that is discontinuous by analyzing the reply signals when the transmission line is determined to be cut off.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic circuit block diagram illustrating a conventional control system; and

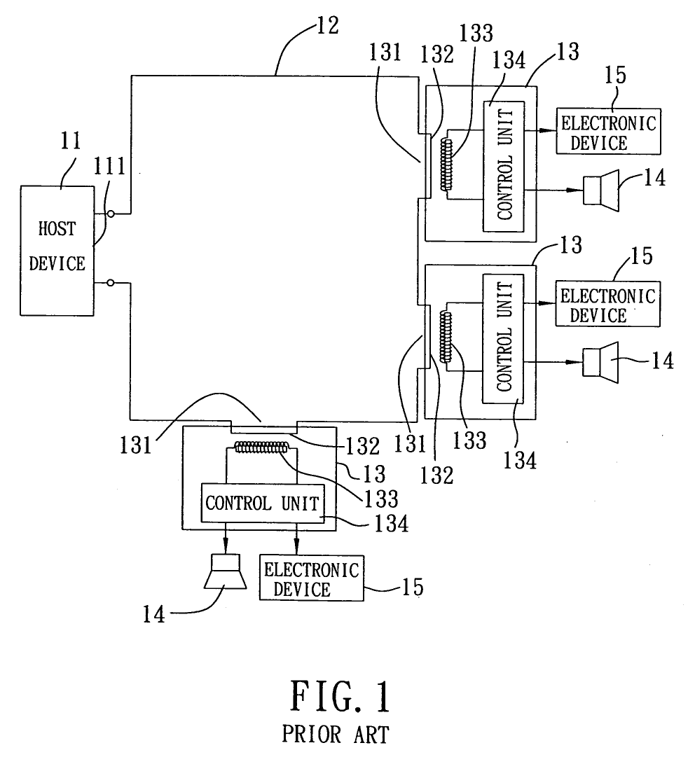

FIG. 2 is a schematic circuit block diagram illustrating the preferred embodiment of an open-loop monitoring system according to the present invention.

### DETAILED DESCRIPTION OF THE PREFERRED EMBODIMENT

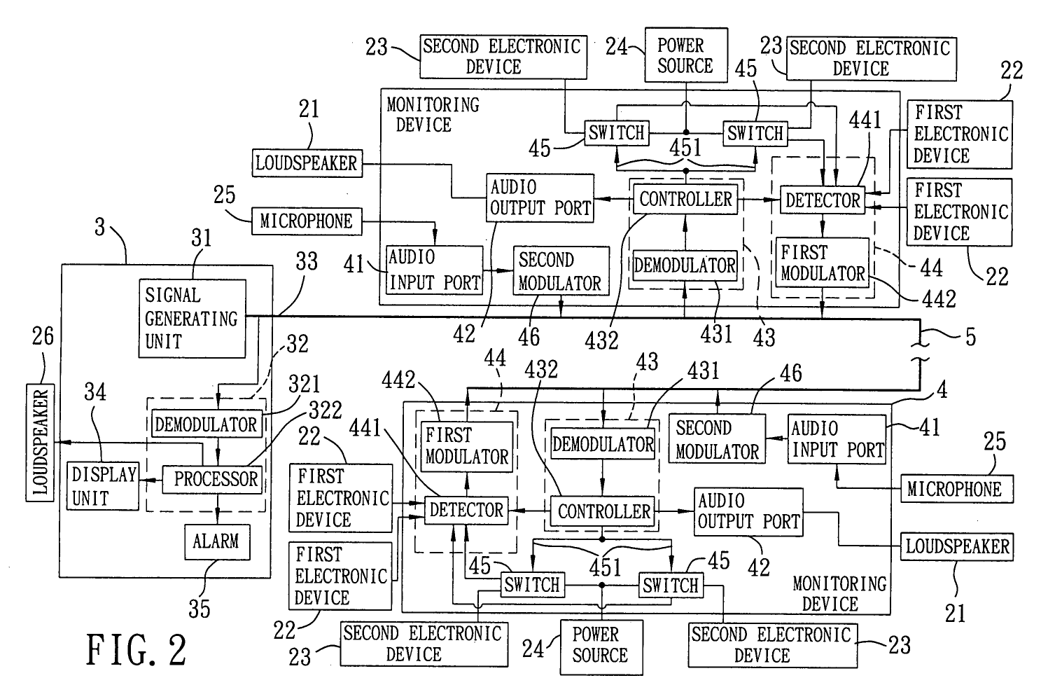

Referring to FIG. 2, the preferred embodiment of an open-loop monitoring system according to the present invention is shown to include a host device 3, and a plurality of monitoring devices 4 coupled to the host device 3 through a single transmission line 5 such that the host device 3 and the monitoring devices 4 constitute an open-loop structure. In this embodiment, each monitoring device 4 is adapted to be coupled to a loudspeaker 21, a plurality of first electronic devices 22, such as smoke detectors, gas detectors or burglar alarms, a plurality of second electronic devices 23, such as lamp devices or audio equipments, and a sound collecting device, such as a microphone 25. The open-loop monitoring system is operable to transmit audio signals to the loudspeaker 21 coupled to each monitoring device 4, controls supply of electric power to the second electronic devices 23 coupled to each monitoring device 4, and detects states of the first electronic devices 22 coupled to each monitoring device 4.

The host device 3 has a coupling end 33 coupled to one end of the transmission line 5 and includes a signal generating unit 31, a processing unit 32, a display unit 34, and an alarm 35 in this embodiment.

The signal generating unit 31 is coupled to the coupling side 33, is operable to generate encoded signals, and outputs the encoded signals through the coupling end 33 to the transmission line 5. In this embodiment, the encoded signals include audio signals, control signals and monitoring signals. It is noted that the encoded signals are in the form of carrier waves through modulation.

The processing unit 32 includes a demodulator 321 coupled to the coupling end 33, and a processor 322 coupled to the demodulator 321, the display unit 34 and the alarm 35, and adapted to be coupled to a loudspeaker 26.

In this embodiment, each monitoring device 4 includes an audio input port 41, an audio output port 42, a control unit 43, a detecting unit 44, and a plurality of switches 45.

For each monitoring device 4, the audio input port 41 is adapted to be coupled to the microphone 25 that collects sound to generate an audio signal. The audio output port 42 is adapted to be coupled to the loudspeaker 21.

In this embodiment, the control unit 43 includes a demodulator 431 and a controller 432. The demodulator 431 is coupled to the transmission line 5 for receiving and demodulating the encoded signals therefrom, and outputs the encoded signals demodulated thereby. The controller 432 is coupled to the demodulator 431 for receiving the encoded signals therefrom, identifies audio signals, a monitoring signal and a control signal from the encoded signals received thereby, and outputs the audio signals, the monitoring signal and the control signal, wherein the audio signals are outputted to the loudspeaker 21 through the audio output port 42 such that the loudspeaker 21 reproduces the audio signals.

Each switch 45 is adapted to be coupled between a power source 24 and the corresponding second electronic device 23, has a control end 451 coupled to the controller 432 of the control unit 43 for receiving the control signal therefrom, and is operable, in response to the control signal, between an ON-mode, where electric power from the power source 24 is supplied to the corresponding second electronic device 23, and an OFF-mode, where the electric power from the power source 24 is not supplied to the corresponding second electronic device 23.

In this embodiment, the detecting unit 44 includes a detector 441 and a first modulator 442. The detector 441 is coupled to the controller 432 of the control unit 43, the switches 45 and the first electronic devices 22, receives the monitoring signal from the controller 432, detects, in response to the monitoring signal received thereby, whether each first electronic device 22 is activated or deactivated and operation of each switch 45, and generates a detecting output based on a detection result made thereby. The first modulator 442 is coupled to the detector 441, receives the detecting output from the detector 441, modulates the detecting output received thereby so as to generate a reply signal that is associated with states of the first electronic devices 22 and an operating mode of the switches 45 and that is in the form of carrier waves, and transmits the reply signal to the coupling end 33 of the host device 3 through the transmission line 5. It is noted that, in other embodiments, the detecting unit 44 of each monitoring device 4 can automatically detect the first electronic devices 22 coupled thereto regardless of the monitoring signal received thereby.

Each monitoring device 4 further includes a second modulator 46 coupled to the transmission line 5 and the audio input port 41, adapted to receive the audio signal from the microphone 25 through the audio input port 41, modulating the audio signal received thereby to be in the form of carrier waves, and transmitting the audio signal modulated thereby to the coupled end 33 of the host device 3 through the transmission line 5. It is noted that, in other embodiments, the first and second demodulators 442, 46 of each monitoring device 4 can be integrated into a single demodulator.

Thus, the demodulator 321 of the processing unit 32 of the host device 3 receives and demodulates the reply signal and the audio signal from each monitoring device 4, and outputs the reply signal and the audio signal demodulated thereby to the processor 322 such that the processor 322 obtains state information associated with the first electronic devices 22 coupled to each monitoring device 4 and operating mode information associated with the switches 45 of each monitoring device 4 based on the reply signal received thereby. The audio signal received by the processor 322 is reproduced by the loudspeaker 26. Therefore, communication between the host device 3 and the monitoring devices 4 is attained.

The processor 322 of the processing unit 32 of the host device 3 determines whether the transmission line 5 is cut off based on the reply signals demodulated by the demodulator 321, and obtains condition information indicating a section of the transmission line 5 that is discontinuous by analyzing the reply signals when the transmission line 5 is determined to be cut off.

The display unit 34 is controlled by the processor 322 to display the condition information associated with the transmission line 5, and the state information and the operating mode information corresponding to the reply signal from each monitoring device 4 thereon.

The alarm 35 is controlled by the processor 322 to generate an alarm output when the processor 322 determines that the transmission line 5 is cut off.

In sum, due to the presence of the detecting unit 44 of each monitoring device 4, and the alarm 35, cutting off of the transmission line 5 can be promptly detected and a user can be alarmed. Furthermore, the processing unit 32 of the host device 3 can obtain the condition information indicating the discontinuous section of the transmission line 5 when the transmission line 5 is cut off, thereby reducing a time period required for checking and repairing the transmission line 5. Therefore, the open-loop monitoring system of the present invention can effectively monitor operation of the first and second electronic devices 22, 23 coupled to each monitoring device 4 through the condition information, the state information and the operating mode information displayed on the display unit 34.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An open-loop monitoring system comprising:
a host device; and
a plurality of monitoring devices coupled to said host device through a single transmission line such that said host device, said monitoring devices and said transmission line constitute an open-loop structure;
wherein said host device has a coupling end coupled to one end of said transmission line, and includes a signal generating unit coupled to said coupling end, operable to generate encoded signals and outputting the encoded signals through said coupling end to said transmission line;
each of said monitoring devices including
a control unit coupled to said transmission line for receiving the encoded signals therefrom, identifying a monitoring signal from the encoded signals received thereby, and outputting the monitoring signal, and
a detecting unit including
a detector adapted to be coupled to a plurality of first electronic devices, coupled to said control unit for receiving the monitoring signal therefrom, detecting, in response to the monitoring signal received thereby, whether each of the first electronic devices is activated or deactivated, generating a detecting output associated with states of the first electronic devices based on a detection result made thereby, and
a first modulator coupled to said detector and said transmission line, receiving the detecting output from said detector, modulating the detecting output received thereby so as to generate a reply signal that is in the form of carrier waves, and transmitting the reply signal to said coupling end of said host device through said transmission line; and
said host device further including a processing unit that includes
a demodulator coupled to said coupling end for receiving and demodulating the reply signal from each of said monitoring devices, and outputting the reply signal demodulated thereby, and
a processor coupled to said demodulator, receiving the reply signal from said demodulator and obtaining state information corresponding to the reply signal from each of said monitoring devices, said processor determining whether said transmission line is cut off based on the reply signals demodulated by said demodulator, and obtaining condition information indicating a section of said transmission line that is discontinuous by analyzing the reply signals when said transmission line is determined to be cut off.

2. The open-loop monitoring system as claimed in claim 1, wherein:
said control unit of each of said monitoring devices further identifies a control signal from the encoded signals received thereby, and outputs the control signal;
each of said monitoring devices further includes a plurality of switches each adapted to be coupled between a power source and a second electronic device, having a control end coupled to said control unit for receiving the control signal therefrom and operable, in response to the control signal, between an ON-mode, where electric power from the power source coupled thereto is supplied to the second electronic device coupled thereto, and an OFF-mode, where the electric power from the power source coupled thereto is not supplied to the second electronic device coupled thereto;
said detector of said detecting unit of each of said monitoring devices is coupled to said switches, and further detects operation of each of said switches in response to the monitoring signal received thereby such that the reply signal generated by said detecting unit is further associated with an operating mode of said switches; and
said processor of said host device further obtains operating mode information associated with said switches of each of said monitoring devices.

3. The open-loop monitoring system as claimed in claim 2, wherein:
the encoded signals generated by said signal generating unit of said host device are in the form of carrier waves through modulation; and
said control unit of each of said monitoring device includes
a demodulator coupled to said transmission line for receiving and demodulating the encoded signals therefrom, and outputting the encoded signals demodulated thereby, and
a controller coupled to said demodulator, said detector of said detecting unit and said switches of a corresponding one of said monitoring device, receiving the encoded signals from said demodulator, identifying the monitoring signal and the control signal from the encoded signals received thereby, and outputting the monitoring signal and the control signal.

4. The open-loop monitoring system as claimed in claim 3, wherein said host device further includes a display unit coupled to said processor for displaying the condition information associated with said transmission line, and the state information and the operating mode information corresponding to the reply signal from each of said monitoring devices thereon.

5. The open-loop monitoring system as claimed in claim 3, wherein:
the encoded signals generated by said signal generating unit of said host device include audio signals;
each of said monitoring devices further includes an audio output port coupled to said controller of said control unit and adapted to be coupled to a loudspeaker; and
said controller of said control unit of each of said monitoring devices identifies audio signals from the encoded signals received thereby, and is adapted to output the audio signals identified thereby to the loudspeaker through said audio output port such that the loudspeaker reproduces the audio signals.

6. The open-loop monitoring system as claimed in claim 1, wherein said host device further includes an alarm coupled to said processor, and controlled by said processor to generate an alarm output when said processor determines that said transmission line is cut off.

7. The open-loop monitoring system as claimed in claim 1, wherein:
each of said monitoring devices further includes
an audio input port adapted to be coupled to a sound collecting device that collects sound to generate an audio signal, and
a second modulator coupled to said audio input port and said transmission line, adapted to receive the audio signal from the sound collecting device through said audio input port, modulating the audio signal received thereby to be in the form of carrier waves, and transmitting the audio signal modulated thereby to said coupling end of said host device through said transmission line;
said demodulator of said processing unit of said host device demodulates the audio signal from said second modulator of each of said monitoring devices, and outputs the audio signal demodulated thereby to said processor; and
said processor of said processing unit of said host device is adapted to be coupled to a loudspeaker for reproducing the audio signal from said processor.

8. An open-loop monitoring system comprising:
a host device; and
a plurality of monitoring devices coupled to said host device through a single transmission line such that said host device, said monitoring devices and said transmission line constitute an open-loop structure, each of said monitoring devices including
a detector adapted to be coupled to a plurality of electronic devices, detecting whether each of the electronic devices is activated or deactivated, generating a detecting output associated with states of the electronic devices based on a detection result made thereby, and
a modulator coupled to said detector and said transmission line, receiving the detecting output from said detector, modulating the detecting output received thereby so as to generate a reply signal that is in the form of carrier waves, and transmitting the reply signal to said transmission line;
wherein said host device has a coupling end coupled to one end of said transmission line, and includes a processing unit that includes
a demodulator coupled to said coupling end for receiving and demodulating the reply signal from each of said monitoring devices, and outputting the reply signal demodulated thereby, and
a processor coupled to said demodulator, receiving the reply signal from said demodulator and obtaining state information corresponding to the reply signal from each of said monitoring devices, said processor determining whether said transmission line is cut off based on the reply signals demodulated by said demodulator, and obtaining condition information indicating a section of said transmission line that is discontinuous by analyzing the reply signals when said transmission line is determined to be cut off.
